(19) United States
(12) Patent Application Publication
(10) Pub. No.: US 2022/0256992 A1
(43) Pub. Date: Aug. 18, 2022

(54) AUTOMATIC SHAMPOO BOWL AND CHAIR

(71) Applicant: Tameka Nicole Williams, Euclid, OH (US)

(72) Inventor: Tameka Nicole Williams, Euclid, OH (US)

(21) Appl. No.: 17/178,584

(22) Filed: Feb. 18, 2021

(51) Int. Cl. A45D 19/10; A45D 44/10; A47C 1/06; A47C 1/11; A61H 35/00

(52) U.S. Cl. CPC A45D 19/10; A45D 44/10; A61H 35/008; A47C 1/11; A47C 1/06

(57) ABSTRACT

According to an embodiment of the present invention, there is disclosed an automatic shampoo bowl and chair designed as a combination shampoo bowl and hair salon chair that automatically shampoos a user's hair. The automatic shampoo bowl and chair includes a salon chair for enabling the user to sit down on it for receiving a haircut. The salon chair includes a back rest, a pair of arm rests, and a seat cushion. Further included is a supporting structure for supporting the seat. Further included is a sink, a pair of automatic massage hands for automatically shampooing and massaging the user's head and hair, and a massaging foot portion.

### TECHNICAL FIELD OF THE INVENTION

The present invention relates to an automatic shampoo bowl and chair, and more particularly to an automatic shampoo bowl and chair designed as a combination shampoo bowl and hair salon chair that automatically shampoos a user's hair.

### BACKGROUND OF THE INVENTION

Millions of people each year seek out the services of a professional hair salon to style or chemically treat their hair. The salon typically has a separate sink station, where attendants can apply shampoo or conditioner, massage the scalp, apply chemicals and then rinse customers' hair. At the sink station, it is necessary to have the customer's head at the upper level of the sink. Customarily, the customer sits in a chair which faces away from the sink and which reclines to bring the customer's head over the edge of the sink basin and oriented toward the water supply. Salon or styling chairs are widely used by beauticians and other individuals performing a service for someone seated in such chairs.

While this arrangement optimizes the distance between the customer's head and the water supply, and minimizes liquid spillage onto the floor, it undoubtedly strains the neck muscles. Having a shampoo, scalp massage, rinse, conditioner, second scalp massage and second rinse can take over five minutes. State of the art salon sinks often have an integral groove suggesting where a customer can lay her neck, but this groove is rigid and does not prevent overextension. What is supposed to be a relaxing and pampering experience becomes stressful and painful, particularly for salon customers of a certain age.

### SUMMARY OF THE INVENTION

According to an embodiment of the present invention, there is disclosed an automatic shampoo bowl and chair designed as a combination shampoo bowl and hair salon chair that automatically shampoos a user's hair. The automatic shampoo bowl and chair includes a salon chair for enabling the user to sit down on it for receiving a haircut. The salon chair includes a back rest, a pair of arm rests, and a seat cushion. Further included is a supporting structure for supporting the seat. Further included is a sink, a pair of automatic massage hands for automatically shampooing and massaging the user's head and hair, and a massaging foot portion.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three dimensional view of the automatic shampoo bowl and chair, in accordance with the present invention.

FIG. 2 is a side view of the automatic shampoo bowl and chair, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader and should not in any way be interpreted as limiting.

Both men and women utilize the services of barbers and beauticians in order to have their hair styled, shampooed and rinsed, dyed, or to have a permanent performed. A procedural element of all the aforementioned is the reclining of the individual, rearwardly, in the barber or beautician's chair, so that the chair can be positioned over an adjacent sink for rinsing with water. This positioning of the individual is often awkward and uncomfortable in that the person's head is oftentimes positioned lower than the chest cavity, and that portion of the person's head having active hair follicles, must extend over the sink.

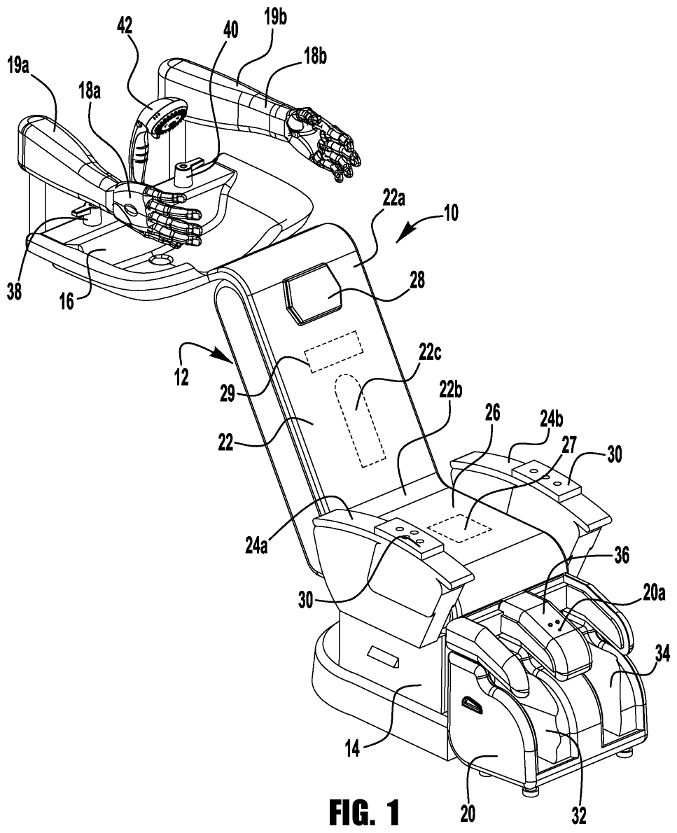

The automatic shampoo bowl and chair 10 (hereinafter chair 10) is designed as a combination shampoo bowl and hair salon chair that automatically shampoos a person's hair. As shown in FIG. 1, the chair 10 according to the present invention includes a salon chair 12 for enabling a user to sit down on it for receiving a haircut, a supporting structure 14 for supporting the seat at a certain height, a sink 16, a pair of automatic massage hands 18a and 18b, and a massaging foot unit 20.

The chair 10 is designed to automatically shampoo a person's hair. The stylist could perform other duties while the person's hair is being automatically shampooed. This would save the stylist time and effort. Further, the chair 10 is designed to enhance the person's comfort and improve efficiency while having their hair shampooed. The process utilized by the chair 10 will contribute to greater accuracy, precision, and ease in shampooing. When activated, the pair of automatic massage hands 18a and 18b will automatically shampoo and massage the user's head and hair.

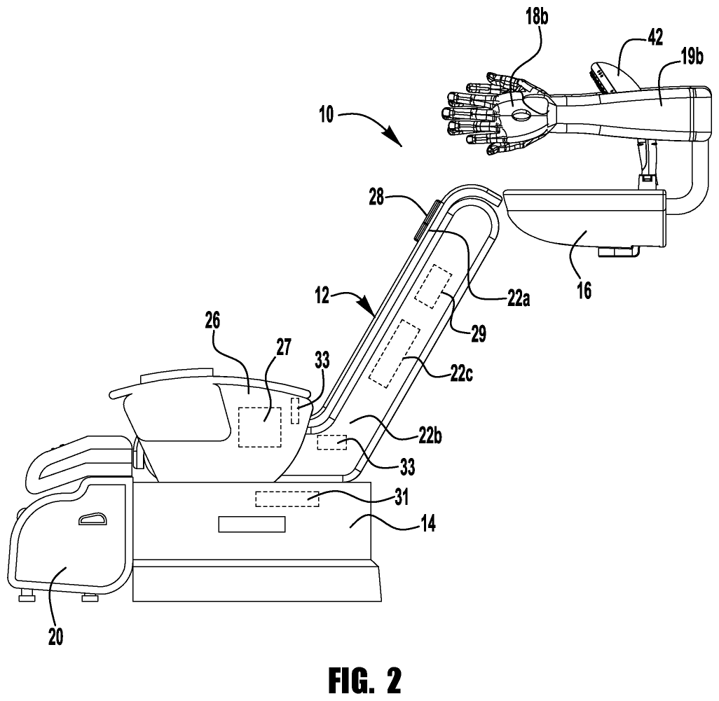

As illustrated in FIGS. 1 and 2, the salon chair 12 includes a back rest 22, a pair of arm rests 24a and 24b, a seat cushion 26, and the massaging foot unit 20. The overall seating surfaces of the salon chair 12 may be conventionally upholstered, with conventional materials such as leather, vinyl, or cloth upholstery. The back rest 22 is preferably ergonomically configured, including at least a lumbar support 22c, and is shaped to support the spine of a seated occupant in an ergonomically correct position. A head rest 28 is preferably disposed at a top portion 22a of the back rest 22 to support the head of a seated occupant or user and to increase the comfort of the user. The seat 26 of the salon chair 12 may also be ergonomically designed.

The seat cushion 26 is installed in such a manner as to be movable back and forth, and up and down over the supporting structure 14 so that the salon chair 12 can be properly adjusted. Both the seat cushion 26 and back rest 22 contain a massaging mechanism 27 and 29, respectively, to enhance the person's comfort. For example, a plurality of massage units may be provided for providing hands-free massage to the neck, upper back, lower back, buttocks and hamstrings of the person in the chair 10 user, respectively. More or less massage units may be provided in different locations of the chair to massage different muscle groups or areas as desired.

Massage units may comprise ball-shaped or other rounded implements which deliver the massaging effects to the seated user through the cushion/fabric of the chair. The massage units are connected to a power source 31, preferably located within the supporting structure 14. The massage units are operated utilizing the controls 30, as described hereinafter, may be adapted to direct the massage units to provide e.g., percussive, rolling, kneading, vibration, tapping, etc. movements and other massage techniques.

As illustrated in FIG. 1, the lower edge 22b of the back rest 22 is pivotally hinge-connected so that the user can adjust the inclination angle of the back rest suitably to his or her comfortable feeling. It must be noted that the back rest 22 and seat cushion 26 each may include a heating element 33, such as but not limited to, a built-in electrical resistance heater, for heating portions of the person's body, e.g., the back, shoulders and legs. A thermostat may be provided for safeguarding the system against overheating. All electrical systems may be low voltage in order to meet applicable regulations. The temperature of the heater may be regulated utilizing the controls 30.

The pair of arm rests 24a and 24b may include at least two pivotable/rotatable joints to facilitate a full range of motion, e.g., at predetermined increments or to an infinite number of positions. Once a desired position is achieved, such attained position may be locked into place. Alternatively, arm rests 24a and 24b may be comprised of a unitary flexible, formable material that may be shaped or bent in any desired direction to facilitate placement of the person's arms in various positions.

Preferably, the arm rests 24a and 24b contain controls 30. The controls 30 allow the user to control the various functionality of the chair 10. This can include the various massage functionality throughout the chair 10, the height and angle of the chair 10, the speed and intensity of the massage hands 18a and 18b, and any other desired functionality.

As seen in FIG. 1, the massaging foot unit 20 may be connected to the supporting structure 14. The supporting structure 14 will contain the power source 31 to power the various electronic functionality of the massaging foot portion 20, such as the massage elements and heating elements.

The massaging foot portion 20 comprises two cavities 32 and 34 in which the left foot and right might be placed, respectively. The cavities 32 and 34 of the massaging foot portion 20 may be adjustable for different foot sizes, such as (but not limited) by means of controls 36 located on the top 20a of the massaging foot portion. One or more heating elements may be disposed within each of the cavities 32 and 34 for warming the feet during massage.

The foot massage unit 20 may comprise sole massage elements for massaging the sole of the foot. Sole massage elements may comprise a plurality of rollers, such as but not limited to, sets of two rollers per element. Additionally, or alternatively, foot massage unit 20 may comprise toe massage elements for massaging the toes. The toe massage elements may comprise a plurality of sliding/rolling massagers. Sole massage elements and toe massage elements may be spring mounted for biasing movement up and down. A motor, generally located within the supporting structure 14, may actuate and control motion of the massage elements and their rollers. Different vibration speeds may be provided to enable different kinds of massages on the sole and toes.

Preferably, the supporting structure 14 contains a power source 31, and a controller, which may control some characteristic of operations of the chair 10. These features include the various heating elements and massage elements that are included with the chair 10. Controller may control characteristics, such as but not limited to, massage intensity (e.g., massage strokes that press harder on the body, or more soothing, gentle massage strokes), massage type (e.g., shiatsu, kneading, rolling, chopping, etc.), massage direction (e.g., up/down, sideways, circular, curvilinear, etc.), and operations on the head in addition to massaging, e.g., washing, shampooing, and/or rinsing. In this manner, the person sitting in the chair 10 or the barber (may select the type of massage preferred, the duration and location of the massage, and which areas or combination of areas are to be massaged. For example, the feet may be massaged while the person is being shampooed and having a neck massage.

As seen in FIGS. 1 and 2, the sink 16 is positioned with respect to the salon chair 12 so as to be adapted for washing the head of a person sitting in the chair. In one embodiment of the invention, the sink 16 may be provided separately from the salon chair 12. In another embodiment of the invention, as illustrated in FIGS. 1 and 2, the sink 16 may be provided together with the salon chair 12, forming the complete automatic shampoo bowl and chair 10. The sink 16 may comprise a stationary basin or a tiltable or movable basin, for example. The sink 16 includes traditional elements such as a hot and coldwater knobs 38 and 40, a spray hose 42 to direct water onto the user's hair, and a control mechanism for regulating the water through the spray hose.

The pair of automatic massage hands 18a and 18b are disposed above the sink 16. Each of the automatic massage hands 18a and 18b is attached to a respective arm 19a and 19b that is attached to the wall or the chair itself. The massage hands 18a and 18b may be moved or adjusted with respect to the sink 16 in a number of directions. For example, each of the massage hands 18a and 18b may be moved independently of the other hand sideways, and/or in an up/down direction, and/or in a front/back direction. Accordingly, any portion of the head or scalp of the user in the chair 10 may be massaged with massage hands 18a and 18b. There may be holes disposed within each of the massage hands 18a and 18b to dispel water therethrough.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. An automatic shampoo bowl and chair designed as a combination shampoo bowl and hair salon chair that automatically shampoos a user's hair; comprising;
a salon chair for enabling the user to sit down on it for receiving a haircut;
the salon chair including a back rest, a pair of arm rests, and a seat cushion;
a supporting structure for supporting the seat,
a sink;
a pair of automatic massage hands for automatically shampooing and massaging the user's head and hair; and
a massaging foot unit.

2. The automatic shampoo bowl and chair of claim 1 wherein overall seating surfaces of the salon chair may be conventionally upholstered from a group of materials consisting of leather, vinyl, and cloth upholstery.

3. The automatic shampoo bowl and chair of claim 1 wherein the back rest is ergonomically configured, including a lumbar support shaped to support the user's spine in an ergonomically correct position.

4. The automatic shampoo bowl and chair of claim 3 wherein the head rest is disposed at a top portion of the back rest to support the user's head and increase the user's comfort.

5. The automatic shampoo bowl and chair of claim 4 wherein the seat cushion is installed to be movable back and forth, and up and down over the supporting structure so as to provide adjustment of the salon chair.

6. The automatic shampoo bowl and chair of claim 5 wherein the seat cushion and back rest each contain a massage unit to enhance the person's comfort.

7. The automatic shampoo bowl and chair of claim 6 wherein the massage units are connected to a power source located within the supporting structure.

8. The automatic shampoo bowl and chair of claim 7 wherein the massage units are operated utilizing controls to direct the massage units to provide massage techniques.

9. The automatic shampoo bowl and chair of claim 8 wherein a lower edge of the back rest is pivotally hinge-connected so that the user can adjust the inclination angle of the back rest with respect to the seat cushion.

10. The automatic shampoo bowl and chair of claim 9 wherein the back rest and seat cushion each include a heating element, which is regulated utilizing the controls.

11. The automatic shampoo bowl and chair of claim 1 wherein the pair of arm rests may include at least two pivotable/rotatable joints to facilitate a full range of motion of the arm rests and enable the arm rests to be locked into place.

12. The automatic shampoo bowl and chair of claim 11 wherein the pair of arm rests contain controls for the user to control the various functionality of the chair.

13. The automatic shampoo bowl and chair of claim 1 wherein the massaging foot portion comprises two cavities in which the user's feet are placed.

14. The automatic shampoo bowl and chair of claim 1 wherein the sink positioned with respect to the salon chair is provided separately from the salon chair.

15. The automatic shampoo bowl and chair of claim 1 wherein the sink positioned with respect to the salon chair is provided together with the salon chair, forming a complete automatic shampoo bowl and chair.

16. The automatic shampoo bowl and chair of claim 1 wherein the pair of automatic massage hands are disposed above the sink.

17. The automatic shampoo bowl and chair of claim 16 wherein each of the automatic massage hands is attached to a respective arm that is attached to a wall located adjacent the salon chair.

18. The automatic shampoo bowl and chair of claim 16 wherein each of the automatic massage hands is attached to a respective arm that is attached to the salon chair.

19. The automatic shampoo bowl and chair of claim 16 wherein each of the massage hands may be moved independently of the other massage hand.

20. The automatic shampoo bowl and chair of claim 15 wherein the sink includes a hot and coldwater knob, a spray hose to direct water onto the user's hair, and a control mechanism for regulating the water through the spray hose.
